(19) United States
(12) Patent Application Publication
(10) Pub. No.: US 2018/0230836 A1
(43) Pub. Date: Aug. 16, 2018

(54) STATOR VANE SECTION

(71) Applicant: ROLLS-ROYCE plc, London (GB)

(72) Inventors: Ian TIBBOTT, Lichfield (GB); Roderick M. TOWNES, Derby (GB); Andrew KING, Derby (GB)

(73) Assignee: ROLLS-ROYCE plc, London (GB)

(21) Appl. No.: 15/895,068

(22) Filed: Feb. 13, 2018

(30) Foreign Application Priority Data
Feb. 15, 2017 (GB) 1702437.3

(51) Int. Cl. F01D 9/04; F01D 25/12

(52) U.S. Cl. CPC F01D 9/041; F01D 25/12; F05D 2220/32; F05D 2260/202; F05D 2260/201; F05D 2240/80; F05D 2240/12

(57) ABSTRACT

There is disclosed a stator vane section for a gas turbine engine. The stator vane comprises an aerofoil, a first platform at a radial end of the aerofoil, a cooling chamber within the aerofoil and a guide duct within the cooling chamber. An impingement chamber is defined between the first platform and a perforated impingement plate provided on the first platform to receive cooling air through the impingement plate. The guide duct is coupled to the first platform so that a collecting chamber extending around the guide duct is defined between the guide duct and the first platform and the collecting chamber is configured to receive cooling air from the impingement chamber via a plurality of collecting channels, and is configured to direct cooling air to the cooling chamber.

### CROSS-REFERENCE TO RELATED APPLICATION

This application is based upon and claims the benefit of priority from British Patent Application Number 1702437.3 filed Feb. 15, 2017, the entire contents of which are incorporated by reference.

### FIELD OF DISCLOSURE

The present disclosure relates to a stator vane section for a gas turbine engine.

### BACKGROUND

Gas turbine engines typically comprise a number of turbine stages, each turbine stage comprising a series of stators and a series of rotors. Stators, or stator vanes accelerate and re-direct the flow to drive downstream rotors.

Typically, the operating temperature of a core gas flow through the turbine stages is very high, following compression in a compressor and combustion in a combustion chamber. To this extent, it is known to provide a flow of cooling air to both stationary and rotating components of a turbine stage, for example by redirecting a relatively cooler stream of air from an upstream portion of the engine. For example, it is known to provide a flow of cooling air to the interior of a stator vane through an outer radial end of the stator vane.

### SUMMARY

The present disclosure provides a stator vane section for a gas turbine engine, and a gas turbine engine according to the appended claims.

According to a first aspect there is disclosed herein a stator vane section for a gas turbine engine comprising an aerofoil; a cooling chamber within the aerofoil and a guide duct within the cooling chamber to direct cooling air into the cooling chamber; a first platform at a radial end of the aerofoil; an impingement chamber defined between the first platform and a perforated impingement plate provided on the first platform to receive cooling air through the impingement plate; and a collecting chamber configured to receive cooling air from the impingement chamber via a plurality of collecting channels, wherein the collecting chamber is configured to direct cooling air to the cooling chamber.

The collecting chamber may be separate from the guide duct. In other words, the collecting chamber may not be in direct fluid communication with the guide duct.

The collecting chamber may extend around the guide duct. The collecting chamber may be defined between the guide duct and the first platform.

The guide duct may be configured for guiding cooling air into the cooling chamber.

The collecting chamber may be in the form of a closed loop extending around the guide duct. The first platform may comprise a recess which is closed by the guide duct to define the collecting chamber.

The impingement chamber may comprise discrete compartments defined between the first platform and the impingement plate and separated by one or more dividing walls. The one or more dividing walls may be integrally formed with the first platform. At least one collecting channel may fluidically connect each compartment directly with the collecting channel.

The first platform may comprise a by-pass channel for delivering cooling air directly from the impingement chamber to an annulus gas flow through the stator vane section.

The by-pass channel may by-pass the guide duct. The by-pass channel may open into the annulus flow through the stator vane section downstream of the trailing end of the aerofoil. The annulus flow may correspond to a core gas flow (or working gas flow) through stator vane, i.e. the gas flow that is compressed and combusted and subsequently expanded through the turbine to power the gas turbine engine. The annulus flow contrasts with other air flows for auxiliary purposes such as cooling.

The stator vane section may further comprise a second platform at an opposite radial end of the aerofoil to the first platform. A second impingement chamber may be defined between the second platform and a second perforated impingement plate provided on the second platform to receive cooling air through the impingement plate.

The stator vane section may further comprise a second collecting chamber configured to receive cooling air from the second impingement chamber via a plurality of collecting channels. The second collecting chamber may be configured to direct cooling air to the cooling chamber within the aerofoil.

A first plenum chamber may be provided on the opposite side of the first platform from the aerofoil. A second plenum chamber may be provided on the opposite of the second platform from the aerofoil. The guide duct may extend from the first platform to the second platform to deliver cooling air from the first plenum chamber to the second plenum chamber. The second impingement chamber may be configured to receive cooling air from the second plenum chamber.

The guide duct may be coupled to the second platform so that a second collecting chamber extending around the guide duct is defined between the guide duct and the second platform. The second collecting chamber may be configured to receive cooling air from the second impingement chamber via a plurality of collecting channels. The second collecting chamber may be configured to direct cooling air to the cooling chamber.

The stator vane section may further comprise an auxiliary guide duct configured to receive cooling air from the or each collecting chamber and distribute cooling air along a span of the cooling chamber. The guide duct and auxiliary guide duct may be formed as a unitary body having a dividing wall.

The aerofoil and the or each platform may be integrally formed as a stator vane body. The guide duct may be a discrete component assembled into the stator vane body.

According to a second aspect there is disclosed a stator vane section for a gas turbine engine comprising; an aerofoil; first and second platforms at opposite radial ends of the aerofoil; an impingement chamber defined between the second platform and a perforated impingement plate provided on the second platform; a first plenum chamber provided on the opposite side of the first platform from the aerofoil and a second plenum chamber provided on the opposite side of the second platform from the aerofoil; and a cooling chamber within the aerofoil, wherein a guide duct is provided within the cooling chamber which extends from the first platform to the second platform to direct cooling air from the first plenum chamber to the second plenum chamber; and wherein the impingement chamber is configured to receive cooling air from the second plenum chamber through the impingement plate.

The first platform may be at a radially outer end of the aerofoil and the second platform may be at a radially inner end of the aerofoil.

The impingement chamber associated with the second platform may be a second impingement chamber, and the impingement plate associated with the second platform may be a second impingement plate. There may be a first impingement chamber and first impingement plate associated with the first platform.

A stator vane section according to the second aspect may have any of the features described above with respect to the first aspect. A stator vane section according to the second aspect may not have a collecting chamber as described with respect to the first aspect (i.e. the collecting chamber is optional according to the second aspect).

A gas turbine engine may comprise the stator vane section or a plurality of stator vane sections in accordance with the first or second aspects.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

Embodiments of the present disclosure will now be described, by way of example, with reference to the accompanying drawings, in which:

### BRIEF DESCRIPTION OF THE DRAWINGS

FIG. 1 schematically shows a sectional side view of a gas turbine engine;

FIG. 2 schematically shows an isometric cutaway view of part of a stator vane section in a gas turbine engine;

FIG. 3 schematically shows a sectional view of a stator vane section;

FIG. 4 schematically shows an isometric cutaway and sectioned view of part of the stator vane section including two aerofoils;

FIG. 5 schematically shows an isometric view of the stator vane section of FIG. 2 with the perforated impingement plate removed; and

FIG. 6 schematically shows a sectional view of further example stator vane section.

### DETAILED DESCRIPTION

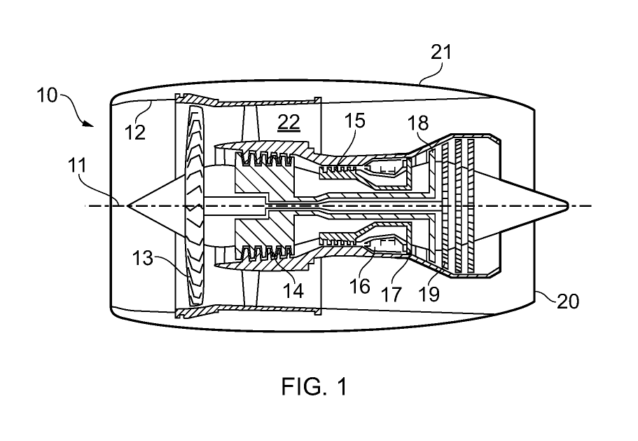

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

In the following description, the terms “upstream” and “downstream” refer to the position of components when installed in a gas turbine engine as described above.

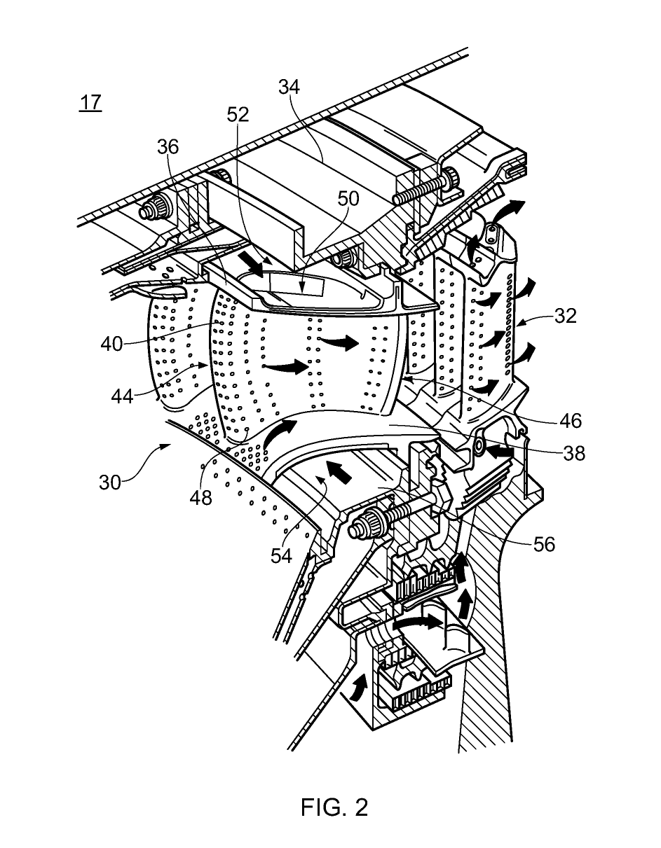

FIG. 2 shows portions of the high pressure turbine 17 of the gas turbine engine 10 with arrows indicating a flow path of cooling air. The high pressure turbine 17 comprises a stator vane ring 30 and a rotating ring or disc of turbine blades 32 downstream of the stator vane ring 30. The stator vane ring 30 and ring or disc of turbine blades 32 are annular and coaxial with the axis of the engine 11.

The stator vane ring 30 comprises an outer platform ring 36, an inner platform ring 38 and a plurality of aerofoils 40.

The outer platform ring 36 is circumferentially extending and defines a radially outer end of the stator vane 30 ring for connection to a casing of the gas turbine. The inner platform ring 38 is circumferentially extending and defines a radially inner end of the stator vane 30 ring. The outer platform ring 36 and inner platform ring 38 are annular and coaxial with the axis of the engine 11. The plurality of aerofoils 40 extend from the outer platform 36 to the inner platform 38 and are arranged at equal, circumferentially spaced intervals around the stator vane ring 30.

The outer and inner platform rings 36, 38 define the radially outer and radially inner gas-washed surfaces of a core annulus flow through the high pressure turbine 17.

A plurality of semi-annular stator vane sections 42 each having at least one aerofoil 40 are assembled to form the stator vane ring 30. In this example, each stator vane section 42 has two aerofoils 40, a radially outer platform 37 corresponding to the outer platform ring 38; and a radially inner platform 39 corresponding to the inner platform ring.

In use with the stator vane sections 42 installed in the gas turbine engine, the aerofoils are positioned in the core annulus gas flow through the high pressure turbine 17. Each aerofoil 40 is hollow and shaped to direct the incoming gas flow from the combustion equipment 16 towards the ring of turbine blades 32 at a specific angle.

Each aerofoil 40 comprises a leading edge 44 at an upstream end of the aerofoil 40 and a trailing edge 46 at a downstream end of the aerofoil 40. Each aerofoil 40 comprises a plurality of film cooling holes 48 distributed over the surface of the aerofoil and in particular on the leading edge 44 of the aerofoil 40 to distribute cooling air from within the hollow aerofoil into a film cooling layer that protects the aerofoil from the hot core annulus flow.

The gas turbine engine includes a radially outer support casing 34 configured to support the stator vane ring 30 in the high pressure turbine 17. The outer platform ring 36 is configured to cooperate with the support casing 34 so that the stator vane ring 30 is suspended from the support casing 34. An outer plenum chamber 52 is defined between the support casing 34 and the outer platform ring 36. The outer platform 37 of each stator vane section 42 comprises an opening 50 which fluidically connects the outer plenum chamber 52 with an interior space of a respective aerofoil 40.

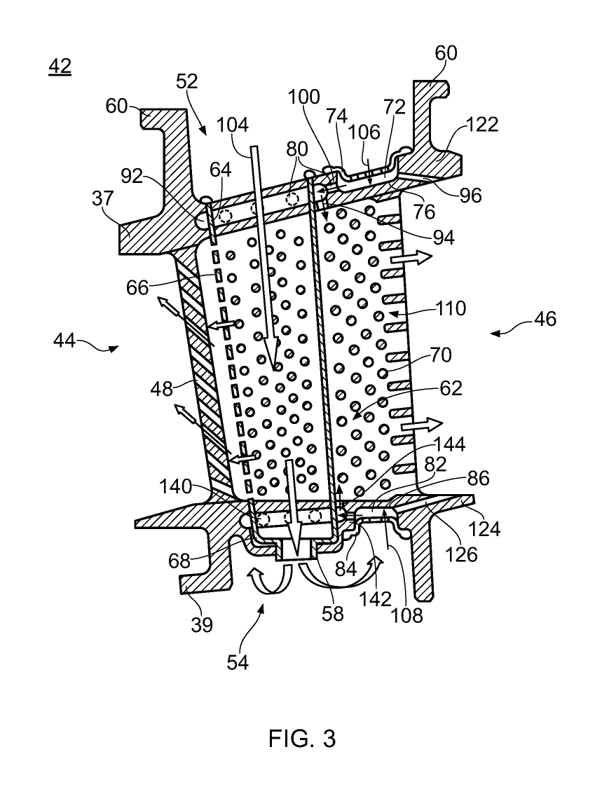

The gas turbine engine further comprises a radially inner combustion casing which provides a radially inner support 56 at its aft end that is configured to support the inner platform ring 38 of the stator vane ring 30. An inner plenum chamber 54 is defined between the inner platform ring 38 and the inner support 56. An opening 58 in the inner platform 39 of each stator vane section 42 (seen in FIG. 3) fluidically connects the inner plenum chamber 54 with the interior space of a respective aerofoil 40.

The arrows in FIG. 2 depict pathways of cooling air in the high pressure turbine 17. The cooling air is drawn from the high pressure compressor 15 along a cooling air pathway which bypasses the combustion equipment 16, such that it is cooler than the core annulus flow provided to the high pressure turbine 17 from the combustion equipment 16. The cooling air flows through each opening 50 to reach the interior of a respective aerofoil 40. At least a portion of the cooling air flows from within the aerofoil through the film cooling holes 48 provided at the leading edge and on each of the pressure and suction surfaces of the blade, to cool the structure of the aerofoil 40 and provide film cooling to the surface thereof. A portion of the cooling air flow may flow through trailing slots 110 (best seen in FIG. 3) along the span of the trailing edge 46 of each aerofoil 40 to cool the trailing edge 46.

FIG. 3 shows a cross-section of an aerofoil 40 of a stator vane section 42. In this example, the outer platform 37, aerofoil 40 and inner platform 39 are integrally formed in a single casting. The outer platform 37 comprises two hooks 60 on an upstream end and a downstream end respectively which cooperate with the support casing 34 to mount the stator vane section 42 thereto.

As explained above, in this example, the stator vane section 42 comprises two aerofoils. The following description refers to an exemplary one of the aerofoils and is equally applicable to both aerofoils of the section 42.

The aerofoil 40 is hollow to define an interior cooling chamber 62 bounded by walls of the aerofoil 40. An inner surface of the hollow aerofoil 40 comprises a plurality of protrusions 70 for promoting heat transfer between cooling air within the aerofoil and the aerofoil walls. The plurality of film cooling holes 48 on the leading end 44 of the aerofoil 40 and each of the pressure and suction surfaces fluidically connect the cooling chamber 62 with the core annulus flow external to the aerofoil 40.

The stator vane section 42 further comprises a guide duct 64 for each aerofoil 40. The guide duct 64 is in the form of a hollow tubular insert which extends along a generally spanwise elongate direction from the outer platform 37 to the inner platform 39 and which has openings at both ends spanwise; an outer opening and an inner opening. The cross section of the tubular insert is substantially constant along its length from the outer opening. In this example, the outer opening substantially corresponds to the cross-section at the radially-outer end of the insert. In contrast, at the inner end of the guide duct 64 has an end wall defining a necked nozzle that forms the inner opening, and is configured to cooperate with a corresponding opening 58 in the inner platform 39. Accordingly, the inner opening of the guide duct 64 is smaller than the outer opening of the guide duct 64.

The guide duct 64 is located in the cooling chamber 62 towards an upstream end of the cooling chamber 62 corresponding to approximately ⅓ chord of the vane. In this example, the outer end of the guide duct 64 is welded to the outer platform 37, whereas the inner end of the guide duct 64 and nozzle is located in an opening of the inner platform 39 without a mechanical fixing. The guide duct 64 is only fixed in place at one end to allow for differential thermal expansion of the guide duct 64 and the stator vane section 42 resulting from the guide duct 64 being relatively cooler than the stator vane section 42 during use.

The outer end of the guide duct 64 is fitted into the opening 50 of the outer platform 37 and the inner end of the guide duct 64 is fitted in the opening 58 of the inner platform 39 so that the guide duct 64 is fluidically connected to both the outer plenum chamber 52 and the inner plenum chamber 54, and provides a pathway for cooling air between the respective plenums. The guide duct 64 further comprises a plurality of cooling holes 66 on an upstream side of the guide duct substantially opposing the leading edge 44 of the aerofoil 40 so that the guide duct 64 is fluidically connected to the cooling chamber 62.

Although an example has been described in which the guide duct 64 is a separate component which is inserted into the aerofoil 40 through the opening 50 of the outer platform 37, it could be integrally formed within the stator vane section 42. For example, the stator vane section 42 including the guide duct 64 could be manufactured by an additive manufacturing process. Further, the guide duct 64 could be fixed to the inner platform 39 at the inner end rather than the outer platform 37 at the outer end, or could be fixed to the platforms 37, 39 at both ends.

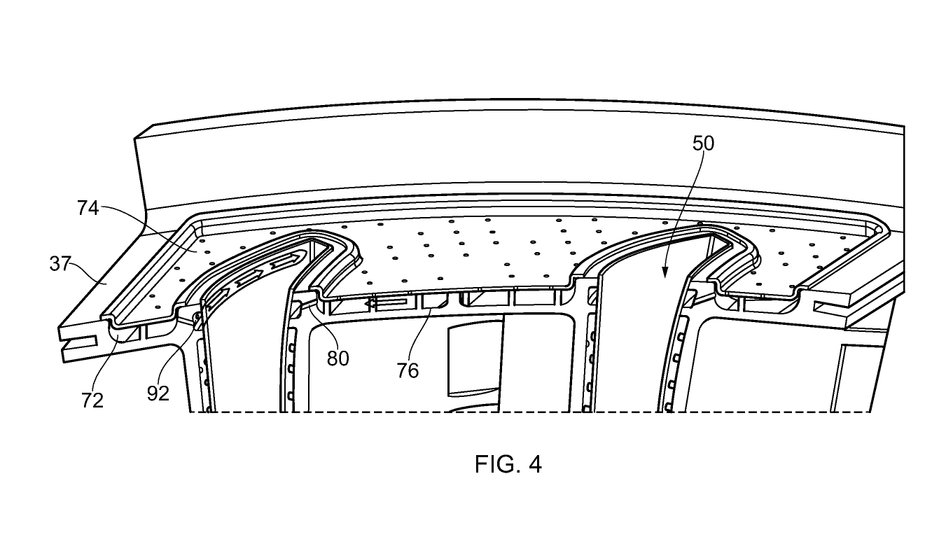

Referring to both FIG. 3 and FIG. 4, the outer platform 37 comprises a recess 76 on its radially outer side which extends around the opening 50 in the outer platform 37. The inner platform 39 comprises a corresponding recess on its radially inner side which extends around the opening 58 of the inner platform 39 in a similar manner (best seen in FIG. 3).

An outer impingement plate 74 is located on the radially outer side of the outer platform 37 and is aligned with the recess 76 so that outer platform 37 and outer impingement plate 74 define an outer impingement chamber 72 therebetween. A corresponding inner impingement plate 84 is located on the radially inner side of the inner platform 39 and is aligned with the recess 86 so that the inner platform 39 and the inner impingement plate 84 define an inner impingement chamber 82.

In this example, the impingement plates 74, 84 are dished so that the edges provide shoulders for resting on respective edges of the recess 76, 86, and which are fixed in place by a weld. The dished shape of the impingement plates 74, 84 allow for differential thermal expansion of the impingement plates 74, 84 relative to the respective platform 37, 39 in use.

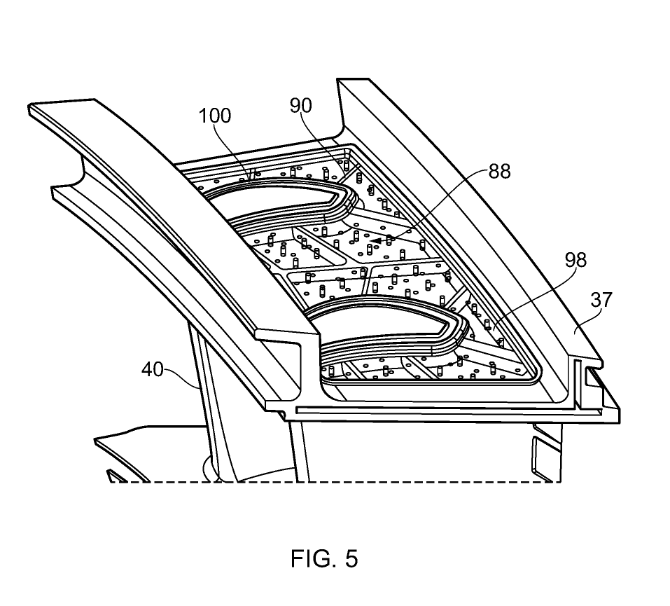

FIG. 5 shows a stator vane section 42 with the outer impingement plate 74 removed to reveal the outer impingement chamber 72. As shown in FIG. 5, there is a plurality of discrete compartments 88 defined by dividing walls 90 in the impingement chamber 72. Each compartment 88 is at least partly defined by a protruding wall 100 of the outer platform 37 which defines the outer opening for receiving the guide duct 64. The inner impingement chamber 82 comprises similar compartments (not shown).

The surfaces of the outer platform 37 and the inner platform 39 which oppose the respective impingement plates 74, 84 are each provided with a plurality of protrusions 98 which extend into the outer impingement chamber 72 and inner impingement chamber 82 respectively for promoting heat transfer between a cooling air in the chamber and the respective platform 37, 39.

Referring again to FIGS. 3 and 4, the impingement plates 74, 84 are perforated with a plurality of impingement holes so that the outer impingement chamber 72 is fluidically connected to the outer plenum chamber 52 and the inner impingement chamber 82 is fluidically connected to the inner plenum chamber 54 to receive a cooling air flow in use.

As described above, the outer platform 37 defines an opening 50 for receiving the guide duct 64, the opening 50 having an inner wall. In this example, the opening 50 and inner wall is defined by the protruding wall 100 which also partly defines the recess 76 for the impingement chamber 72. A groove or channel is defined in the inner wall of the opening in the outer platform 37 such that an outer collecting chamber 92 is defined between the guide duct 64 and the outer platform 37 when the guide duct 64 is installed in the opening. The outer collecting chamber 92 extends completely around the guide duct 64 in a loop.

A corresponding groove or channel is defined in the inner wall of the opening 58 in the inner platform 39 to define an inner collecting chamber 102 between the guide duct 64 and the inner platform 39. The inner collecting chamber 102 also extends completely around the guide duct 64 in a loop.

In this example, the protruding wall 100 of the outer platform 37 separates the outer impingement chamber 72 and the outer collecting chamber 92. A plurality of collecting channels 80 are formed through the protruding wall 100 to fluidically connect the outer impingement chamber 72 with the outer collecting chamber 92. A corresponding plurality of collecting channels 140 are formed in the protruding wall 142 of the inner platform 39 to connect the inner impingement chamber 82 and the inner collecting chamber 102.

Each discrete compartment 88 of the respective impingement chambers 72, 82 is directly fluidically connected to the respective collecting chamber 92, 102 by means of one or more collecting channels 80, 140.

The outer platform 37 and inner platform 39 between the collecting chamber 92, 102 and the cooling chamber 62, comprises a distributing channel 94, 144. The distributing channel 94 fluidically connects the collecting chambers 92, 102 with the cooling chamber 62 and is located at the furthest downstream end of the collecting chamber 92, 102.

Each of the outer platform 37 and inner platform 39 of the stator vane section 42 extend axially aft of the aerofoil 40 such that there is an outer aft extension 122 and an inner aft extension 124 of the respective platforms 37, 39. The outer aft extension 122 is provided with a bypass channel 96 which extends from impingement chamber 72 to the gas-washed surface of the outer platform 37 which defines the outer wall of the annulus flow. The bypass channel 96 opens into the annulus flow downstream of the trailing end of the aerofoil 40, such that a flow of cooling air through the bypass channel may cool the outer aft extension 122.

There is a corresponding bypass channel 126 in the inner platform 39 between the inner impingement chamber 82 and the respective gas-washed surface of the inner platform 39, downstream of the trailing edge of the aerofoil 40.

In use, the hot annulus flow through the engine passes from the upstream end of the stator vane ring 30 to the downstream end of the stator vane ring 30, around the aerofoil 40 and to the ring or disc of turbine blades. The hot annulus flow has come from the combustion equipment 16 and may therefore be hotter than the melting point of the aerofoil 40 material.

Cooling air bypasses the combustion equipment 16 and is fed into the outer plenum chamber 52. The cooling air received in the outer plenum chamber 52 cools the exposed surfaces of the outer platform 36. The following further description is made with respect to the cooling air flow associated with one aerofoil 40 of a respective aerofoil section 42, although it will be appreciated that it applies equally to all portions of the stator vane ring 30.

The cooling air received in the outer plenum chamber 52 is split to follow two distinct paths; a guide duct path 104 and an outer impingement path 106.

On the guide duct path 104, the cooling air flows into the guide duct 64 through the opening 50 of the outer platform 37. This cooling air is guided through the aerofoil 40 by the guide duct 64. A first portion of the cooling air on the guide duct 64 path bleeds from the guide duct 64 through the cooling holes 66 in the upstream side of the guide duct 64 and then flows through the film cooling holes 48 in the leading edge 44 of the aerofoil 40 to provide film cooling on the surface of the aerofoil 40.

A second portion of the cooling air on the guide duct path 104 bleeds through the cooling holes 66 and flows around the exterior of the guide duct 64 within the cooling chamber 62 towards the trailing edge 46 of the aerofoil 40 to provide internal cooling of the aerofoil 40. Such cooling may be enhanced by the protrusions 70 within the aerofoil as described above.

A third portion of the cooling air on the guide duct path 104 travels through the guide duct 64 to the inner opening of the guide duct 64 and through the opening 58 of the inner platform 39 into the inner plenum chamber 54. Cooling air within the inner plenum chamber 54 cools the exposed surfaces of the inner platform 39. From the inner plenum chamber 54, the cooling air follows an inner impingement path 108 as will be described below.

The inner impingement path 108 and the outer impingement path 106 are mirrored through the respective inner and outer components. The following detailed description of the outer impingement path 106 applies equally to the inner impingement path 108.

On the outer impingement path 106, the cooling air passes from the outer plenum chamber 52 through the impingement holes in the outer impingement plate 74 and into the outer impingement chamber 72 where it impinges on the outer platform 37 surface within the impingement chamber 72 including the protrusions 98 to provide cooling of the outer platform 36. The protrusions 98 increase the turbulent mixing of the cooling air, maintain an impingement gap between the impingement plate 74 and the outer platform 37 and increase the exposed surface area of the outer platform 36 material and therefore promote heat transfer from the outer platform 36 to the cooling air.

The perforations in the impingement plate 74 and the dividing walls 90 of the compartments 88 are cooperatively configured to provide an even distribution of cooling air over the outer platform 36 so that the outer platform 36 is evenly cooled.

From each compartment 88 of the outer impingement chamber 72, the cooling air travels through the collecting channels 80 and is collected in the outer collecting chamber 92. Re-collecting the cooling air allows it to be re-distributed for further directed cooling. From the collecting chamber 92, the cooling air passes into the cooling chamber 62 within the aerofoil 40 through the distributing channel 94. Upon entry into the cooling chamber 62, the cooling air mixes with the second portion of cooling air from the guide duct path 104. This mixture cools the internal surface of the aerofoil 40 whilst flowing to the trailing edge 46 of the aerofoil 40.

The mixed cooling air in the cooling chamber 62 travels to the downstream end of the cooling chamber 62 and out of the trailing slots 110 at the trailing end 46 of the aerofoil to join the annulus flow outside the aerofoil 40.

The cooling air flowing along the outer and inner impingement paths 106, 108 and into the cooling chamber 62 via the distributing channels 94, 144 provide additional cooling of the aerofoil 40. Owing to mixing with the chord-wise flow in the cooling chamber 62, the spanwise extent of this additional cooling may be relatively limited. For example, the additional cooling from each path 106, 108 may extend over approximately one third of the span of the aerofoil 40.

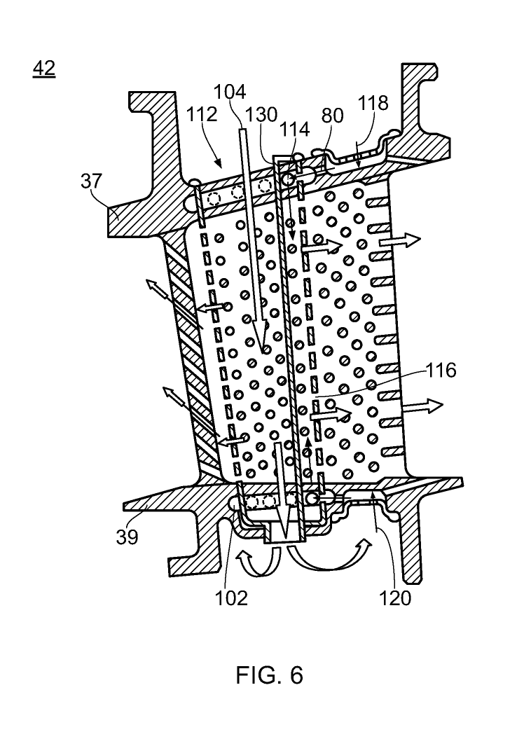

FIG. 6 shows a further example stator vane section 42 in which there is both a first guide duct 112 and an auxiliary guide duct 114 extending between the outer platform 37 and inner platform 39 in place of the guide duct 64 described above with respect to FIG. 3. The first guide duct 112 has the same function and features as the guide duct 64 of FIG. 3, albeit a narrower chordwise profile to accommodate the auxiliary guide duct 114. The auxiliary guide duct 114 replaces and improves the distribution of cooling air into the cooling chamber 62 from the respective collecting chambers 92, 102.

In this example, the first guide duct 112 and auxiliary duct 114 are formed by an insert received in the openings 50, 58 in the outer platform 37 and inner platform 39 so that the outer and inner collecting chambers 92, 102 are defined between the respective platforms 37, 39 and a wall of the insert as described above.

A partition 130 is provided within the insert to define the first guide duct 112 and the auxiliary guide duct 114 on either side. The partition 130 has an outer flange for coupling to the outer platform 37, and extends radially inwardly to the nozzle opening in the inner end of the insert.

The first guide duct 112 is therefore formed between a forward portion of the insert wall and the partition 130, whereas the auxiliary guide duct 114 is formed between the partition 130 and an aft portion of the insert wall. The partition 130 prevents direct fluid communication between the first guide duct 112 and the auxiliary duct 114

In this example, the auxiliary guide duct 114 has closed radial ends such that is does not directly receive cooling air form either of the outer plenum chamber 52 or the inner plenum chamber 54.

Towards each radial end of the auxiliary duct 114, there is at least one channel extending between the respective collecting chamber 92, 102 and the auxiliary duct 114, such that the cooling air from each of the respective impingement paths 106, 108 flows into the auxiliary duct 114 rather than directly into the cooling chamber 62. In this example, there is no channel directly connecting either of the collecting chambers 92, 102 and the cooling chamber 62.

The auxiliary guide duct 114 further comprises cooling holes 116 formed in the aft portion of the insert wall within the cooling chamber 62 to direct the cooling air into the cooling chamber 62 along the spanwise extent of the auxiliary duct 114.

Although it is described that the first guide duct 112 and auxiliary guide duct 114 are separated by a partition, in other examples there may be two separate ducts inserted into the cooling chamber 62, or the ducts may be integrally formed within the platforms 37, 39 and aerofoil of the stator vane section 42 (for example by additive manufacturing).

In use, the cooling air bypasses the combustion equipment and is fed into the outer plenum chamber 52 as in the arrangement of FIG. 3. The cooling air cools the exposed surfaces of the outer platform 36 and can follow two distinct paths; a guide duct path 104 and an outer impingement path 106.

The guide duct path 104 which the cooling air follows is the same as that in the arrangement in FIG. 3. The outer impingement path 118 and inner impingement path 120 are the same as the arrangement in FIG. 3 up to the collecting chamber 92, 102.

When the cooling air reaches the collecting chambers 92, 102, it flows into the auxiliary duct 114 from the collecting chambers 92, 102. The auxiliary duct 114 guides the cooling air along the full span of the cooling chamber 62 so that the cooling air flow is released into the cooling air chamber and distributed along the span of the aerofoil 40. This flow mixes with the second portion from the guide duct path 104 as described above and exits the cooling chamber from the trailing slots 110 to join the annulus flow downstream of the aerofoil 40.

Example stator vane sections as disclosed herein may control the flow of cooling gas therethrough to enable efficient cooling of the stator vane section. In particular, by re-collecting cooling air that has passed through an impingement plate to cool a respective platform, such cooling air can be re-distributed to provide cooling elsewhere. In particular, such cooling air can be distributed into the aerofoil at either radial end, or can be distributed along the span of the aerofoil using the auxiliary duct.

As the collecting chamber extends around the guide duct, it can collect cooling air from different portions of the respective impingement chamber via respective collecting channels. Accordingly, the perforations in the impingement plate can be designed to achieve a desired distribution of cooling on a platform using the cooling air, whilst enabling such cooling air to be re-collected and re-distributed.

When the guide duct is open at both radial ends to allow communication between a first plenum and a second plenum, cooling gas received at one radial end of the blade can be re-distributed to cool platforms at both radial ends, and can be subsequently re-collected and re-distributed into the aerofoil for further cooling.

By enabling efficient use of cooling air to cool the stator vane section, a flow rate of cooling air may be reduced, thereby improving engine efficiency and specific fuel consumption. Further, by re-collecting and distributing cooling gas into the aerofoil for ejection into the annulus flow through the walls of the aerofoil or a trailing edge slot of the aerofoil, mixing losses resulting in the annulus gas flow may be lower than if the same quantity of cooling air were to be discharged into the annulus directly through one of the platforms.

Example stator vane sections according to the present disclosure may be implemented in any of the high pressure turbine, intermediate pressure turbine of low pressure turbine of a gas turbine engine.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A stator vane section for a gas turbine engine comprising:
an aerofoil;
a cooling chamber within the aerofoil and a guide duct within the cooling chamber to direct cooling air into the cooling chamber;
a first platform at a radial end of the aerofoil;
an impingement chamber defined between the first platform and a perforated impingement plate provided on the first platform to receive cooling air through the impingement plate; and
a collecting chamber configured to receive cooling air from the impingement chamber via a plurality of collecting channels, wherein the collecting chamber is configured to direct cooling air into the cooling chamber.

2. A stator vane section for a gas turbine engine according to claim 1, wherein the collecting chamber extends around the guide duct and is defined between the guide duct and the first platform.

3. A stator vane section according to claim 2, wherein the collecting chamber is in the form of a closed loop extending around the guide duct.

4. A stator vane section according to claim 2, wherein the first platform comprises a recess which is closed by the guide duct to define the collecting chamber.

5. A stator vane section according to claim 1, wherein the impingement chamber comprises discrete compartments defined between the first platform and the impingement plate and separated by one or more dividing walls.

6. A stator vane section according to claim 5, wherein the one or more dividing walls are integrally formed with the first platform.

7. A stator vane section according to claim 1, where the first platform comprises a by-pass channel for delivering cooling air directly from the impingement chamber to an annulus flow through the stator vane section.

8. A stator vane section according to claim 7, wherein the by-pass channel opens into the annulus flow through the stator vane section downstream of the trailing end of the aerofoil.

9. A stator vane section according to claim 1, further comprising a second platform at an opposite radial end of the aerofoil to the first platform,
wherein a second impingement chamber is defined between the second platform and a second perforated impingement plate provided on the second platform to receive cooling air through the impingement plate.

10. A stator vane section according to claim 9, wherein a first plenum chamber is provided on the opposite side of the first platform from the aerofoil and a second plenum chamber is provided on the opposite of the second platform from the aerofoil;
and wherein the guide duct extends from the first platform to the second platform to deliver cooling air from the first plenum chamber to the second plenum chamber, the second impingement chamber being configured to receive cooling air from the second plenum chamber.

11. A stator vane section according to claim 9, wherein the guide duct is coupled to the second platform so that a second collecting chamber extending around the guide duct is defined between the guide duct and the second platform;
wherein the second collecting chamber is configured to receive cooling air from the second impingement chamber via a plurality of collecting channels, and is configured to direct cooling air into the cooling chamber.

12. A stator vane section according to claim 1, further comprising an auxiliary guide duct configured to receive cooling air from the or each collecting chamber and distribute cooling air along a span of the cooling chamber.

13. A stator vane section according to claim 12, wherein the guide duct and auxiliary guide duct are formed as a unitary body having a dividing wall.

14. A stator vane section according to claim 1, wherein the aerofoil and the or each platform are integrally formed as a stator vane body, and wherein the guide duct is a discrete component assembled into the stator vane body.

15. A gas turbine assembly comprising a stator vane section in accordance with claim 1.

16. A stator vane section for a gas turbine engine comprising:
an aerofoil;
a cooling chamber within the aerofoil and a guide duct within the cooling chamber to direct cooling air into the cooling chamber;
a first platform at a radial end of the aerofoil;
an impingement chamber defined between the first platform and a perforated impingement plate provided on the first platform to receive cooling air through the impingement plate; and
a collecting chamber configured to receive cooling air from the impingement chamber via a plurality of collecting channels, wherein the collecting chamber is configured to direct cooling air into the cooling chamber, where the first platform comprises a by-pass channel for delivering cooling air directly from the impingement chamber to an annulus flow through the stator vane section, and further comprising an auxiliary guide duct configured to receive cooling air from the or each collecting chamber and distribute cooling air along a span of the cooling chamber.

17. A stator vane section according to claim 16, wherein the guide duct and auxiliary guide duct are formed as a unitary body having a dividing wall.

18. A stator vane section for a gas turbine engine comprising; an aerofoil; first and second platforms at opposite radial ends of the aerofoil; an impingement chamber defined between the second platform and a perforated impingement plate provided on the second platform; a first plenum chamber provided on the opposite side of the first platform from the aerofoil and a second plenum chamber provided on the opposite side of the second platform from the aerofoil; and a cooling chamber within the aerofoil, wherein a guide duct is provided within the cooling chamber which extends from the first platform to the second platform to direct cooling air from the first plenum chamber to the second plenum chamber; and wherein the impingement chamber is configured to receive cooling air from the second plenum chamber through the impingement plate.
